(19) United States
(12) Patent Application Publication
(10) Pub. No.: US 2026/0192870 A1
(43) Pub. Date: Jul. 9, 2026

(54) SPARE TIRE KIT FOR VEHICLE

(71) Applicant: American Honda Motor Co., Inc., Torrance, CA (US)

(72) Inventors: Colin P. Gorey, Columbus, OH (US); Kris Lemmon, Powell, OH (US)

(21) Appl. No.: 19/014,661

(22) Filed: Jan. 9, 2025

(51) Int. Cl. B62D 43/08; B62D 43/10

(52) U.S. Cl. CPC B62D 43/08; B62D 43/10

(57) ABSTRACT

A spare tire kit suitable for arranging and securing a spare tire, in a vertically standing orientation, inside a storge compartment of the vehicle includes a tray adapted to be arranged inside the storage compartment and configured to receive the spare tire in the vertically standing orientation. The spare tire kit also includes a first connector adapted to be attached to a floor of the vehicle on a first side of the tray and facilitates the securing the spare tire inside the tray. Moreover, the spare tire kit includes a second connector adapted to be connected to a sidewall of the vehicle or the floor of vehicle on a second side of the tray and configured to wrap around the spare tire and removably engaged with the first connector to secure the spare tire inside the tray.

### BACKGROUND

Vehicles, such as hatchbacks, sports utility vehicles, multi utility vehicles, and mini-vans, typically, include a cargo space arranged behind the rear seats. Generally, the cargo space includes an area defined underneath a cargo floorboard to store a single spare tire in a horizontal or lying orientation. However, during off-roading or long travel, having an additional spare tire is desirable.

### SUMMARY

In accordance with an embodiment of the present disclosure, a spare tire kit for a vehicle includes a tray adapted to be arranged inside the storage compartment and configured to receive the spare tire in the vertically standing orientation. The spare tire kit further includes a pair of stoppers adapted to be arranged, spaced apart from each other, inside the tray, and the spare tire is arranged between the pair of stoppers to restrict the movement of the spare tire in a longitudinal direction of the vehicle. The spare tire kit also includes a first connector adapted to be attached to a floor of the vehicle on a first side of the tray and facilitates the securing the spare tire inside the tray. Moreover, the spare kit includes a second connector adapted to be connected to a sidewall of the vehicle or the floor of vehicle on a second side of the tray, and the second connector is configured to wrap around the spare tire and removably engaged with the first connector to secure the spare tire inside the tray.

In accordance with another embodiment of the present disclosure, a vehicle includes a vehicle body defining a storage compartment, and the storage compartment includes a first area and a second area adjacent to the first area. The vehicle also includes a tray arranged inside the second area of the storage compartment, and the tray extends in a longitudinal direction of the vehicle to receive a spare tire in a vertically standing orientation. Further, the vehicle includes a pair of stoppers arranged inside the tray and disposed spaced apart from each other in a longitudinal direction to receive the spare tire therebetween, and the pair of stoppers restrict the movement of the spare tire in a longitudinal direction of the vehicle. The vehicle also includes a first connector attached to a floor of the vehicle on a first side of the tray and facilitates a securing of the spare tire inside the tray. Moreover, the vehicle includes a second connector connected to a sidewall of the vehicle or the floor of vehicle on a second side of the tray and configured to wrap around the spare tire and removably engaged with the first connector to secure the spare tire inside the tray.

In accordance with yet a further embodiment of the present disclosure, a spare tire kit for a vehicle includes a tray adapted to be arranged inside the storage compartment and configured to receive the spare tire in the vertically standing orientation. The spare tire kit further includes a first connector adapted to be attached to a floor of the vehicle on a first side of the tray and facilitates the securing the spare tire inside the tray. Furthermore, the spare tire kit includes a second connector adapted to be connected to a sidewall of the vehicle or the floor of vehicle on a second side of the tray and configured to wrap around the spare tire and removably engaged with the first connector to secure the spare tire inside the tray. Moreover, the spare tire kit includes a pair of stoppers adapted to be arranged inside the tray with the spare tire to be arranged between the pair of stoppers to restrict the movement of the spare tire in a longitudinal direction of the vehicle. Also, a cross-strap of the spare tire kit is adapted to be removable engaged to the second connector and the sidewall of the vehicle and extends in a longitudinal direction of the vehicle to secure the spare tire inside the tray and to restrict a lateral movement of the spare tire in a direction away from the sidewall of the vehicle. Furthermore, the spare tire kit includes a wall spacer adapted to be removably attached to the sidewall of the vehicle and to contact the spare tire when arranged inside the tray in the vertically standing orientation, to restrict a lateral movement of the spare tire towards the sidewall.

### BRIEF DESCRIPTION OF THE DRAWINGS

Certain embodiments of the present disclosure will be better understood from the following description taken in conjunction with the accompanying drawings in which:

FIG. 1 is a front perspective view of a vehicle, in accordance with one embodiment of the present disclosure;

FIG. 2 is a perspective view of an inside rear portion of the vehicle depicting a spare tire kit securing a spare tire in a vertically standing orientation inside a storge compartment of the vehicle, in accordance with an embodiment of the present disclosure;

FIG. 3 depicts a perspective view of the spare tire kit, in accordance with an embodiment of the present disclosure;

FIG. 4 depicts a pair of stoppers and a wall spacer of the spare tire kit, in accordance with an embodiment of the present disclosure;

FIG. 5 depicts a first connector, a second connector, and a cross-strap of the spare tire kit, in accordance with an embodiment of the present disclosure;

FIG. 6 illustrates a perspective view of the rear portion of the vehicle and depicting the storage compartment without the spare tire, in accordance with an embodiment of the present disclosure;

FIG. 7 illustrates a perspective view of the rear portion of the vehicle with floorboards removed and depicting a tray and another spare tire arranged in a horizontal orientation adjacent to the tray, in accordance with an embodiment of the present disclosure;

FIG. 8 illustrates a perspective view of the rear portion of the vehicle depicting the pair of stoppers arranged inside the tray and the wall spacer attached to a sidewall of the vehicle, in accordance with an embodiment of the present disclosure;

FIG. 9 illustrates a perspective view of the rear portion of the vehicle depicting the spare tire arranged inside the tray and between the pair of stoppers, in accordance with an embodiment of the present disclosure; and

FIG. 10 depicts perspective view of the rear portion of the vehicle depicting the spare tire arranged inside the tray and secured inside the tray via the first connector and the second connector, in accordance with an embodiment of the present disclosure.

### DETAILED DESCRIPTION OF EXEMPLARY EMBODIMENTS

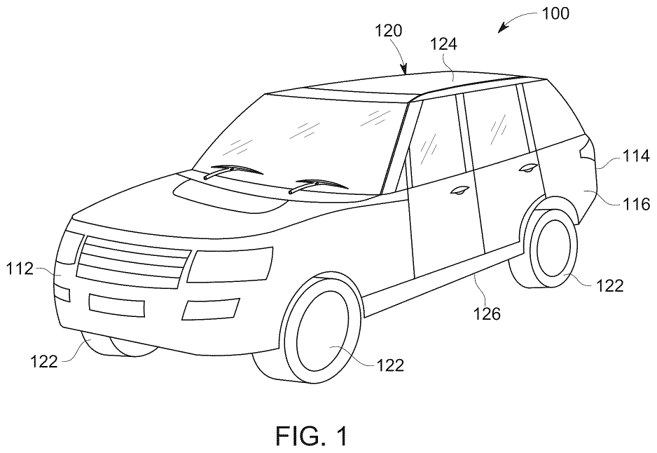

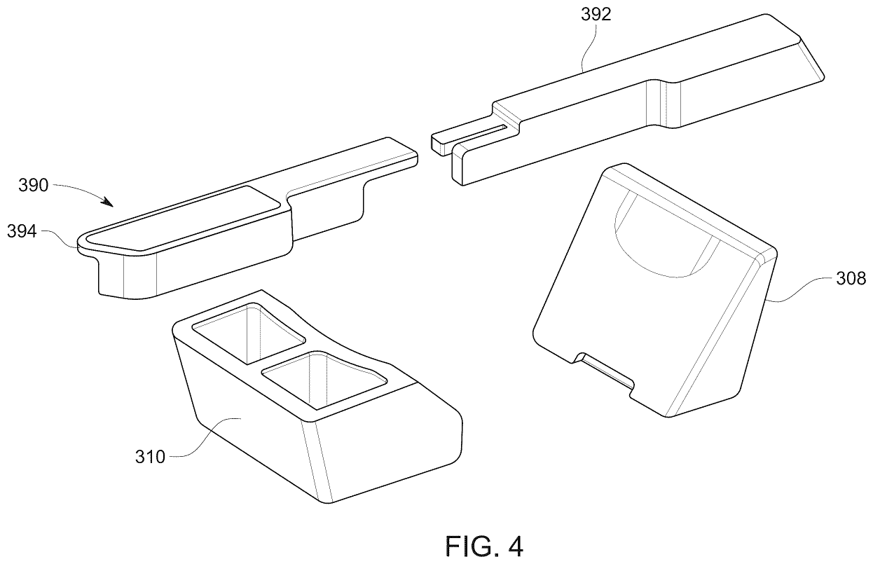

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-10, wherein like numbers indicate the same or corresponding elements throughout the views.

FIG. 1 illustrates a perspective view of a vehicle, indicated generally at 100, in accordance with one embodiment of the present disclosure. The vehicle 100 is shown as a multi-utility vehicle, however, the vehicle 100 in accordance with alternative embodiments can comprise any variety of vehicles, including hatchback, sport utility vehicle, jeep, truck, etc. The vehicle 100 includes a front end 112, a rear end 114, a first longitudinal side 116 (hereinafter referred to as a left side 116), a second longitudinal side 118 (hereinafter referred to as a right side 118), and a vehicle body 120. extending from the front end 112 to the rear end 114 and supported on a plurality of wheels 122.

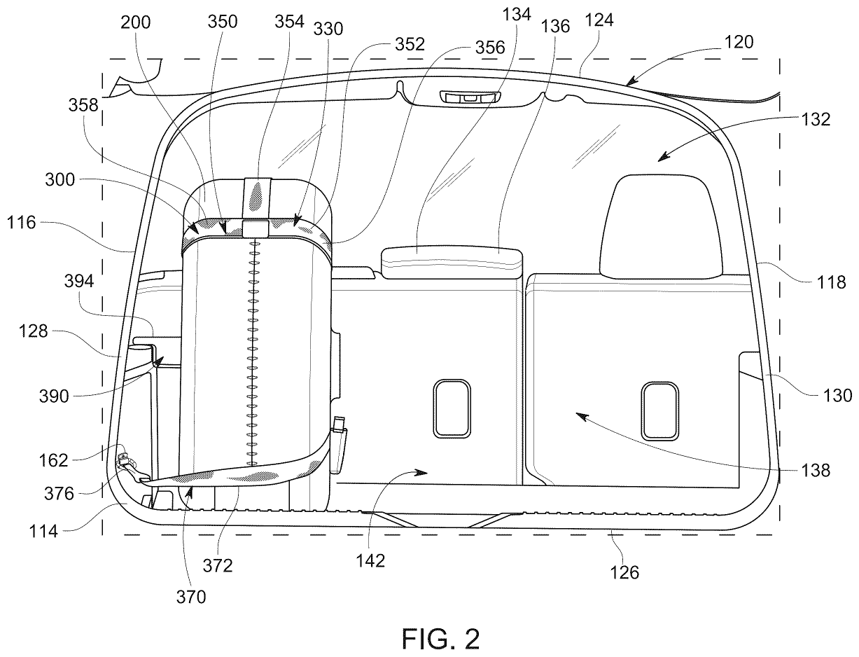

FIG. 2 illustrates a perspective view of an inside rear portion of the vehicle. As shown in FIG. 2, the vehicle body 120 has a roof 124, a floor 126, and a pair of sidewalls 128, 130 extending along the longitudinal sides 116, 118 of the vehicle 100 and supporting the roof 124. The vehicle body defines a passenger compartment 132 including a plurality of seats 134 having one or more rear seats 136 to facilitate a seating of a plurality of passengers including a driver inside the vehicle 100. Further, the vehicle body 120 defines a storage compartment 138 that extends rearwardly of the rear seats 136 of the vehicle body 120. A spare tire 200 is secured in a vertically standing orientation inside the storage compartment 138 of the vehicle 100. To retain the spare tire 200 inside the storage compartment 138, the vehicle 100 includes a spare tire kit 300 with one or more components of the spare tire kit 300 arranged or mounted inside the storage compartment 138 of the vehicle 100.

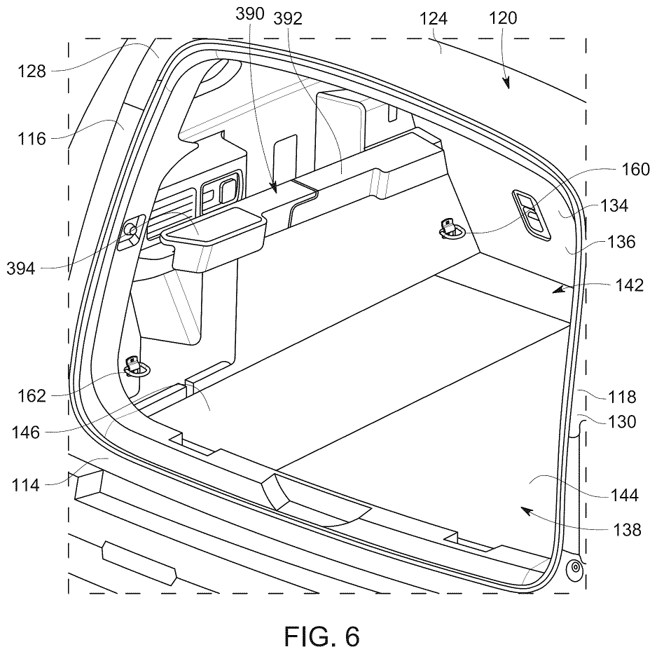

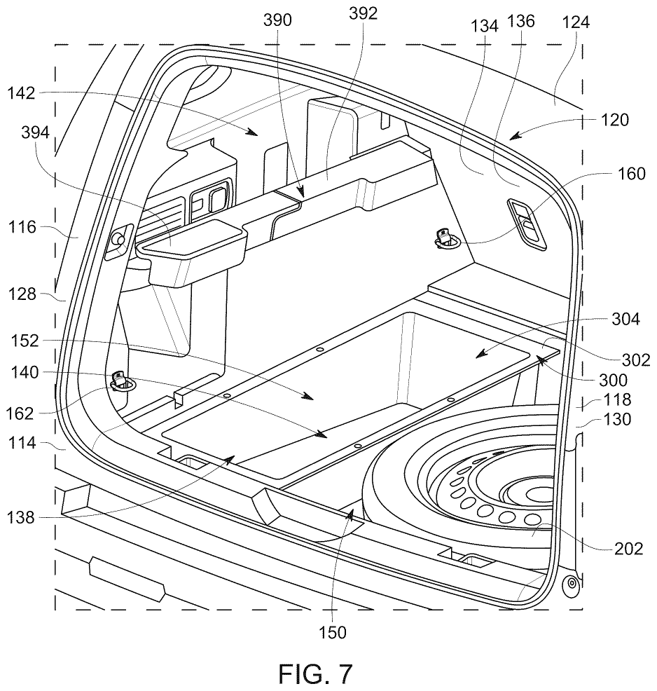

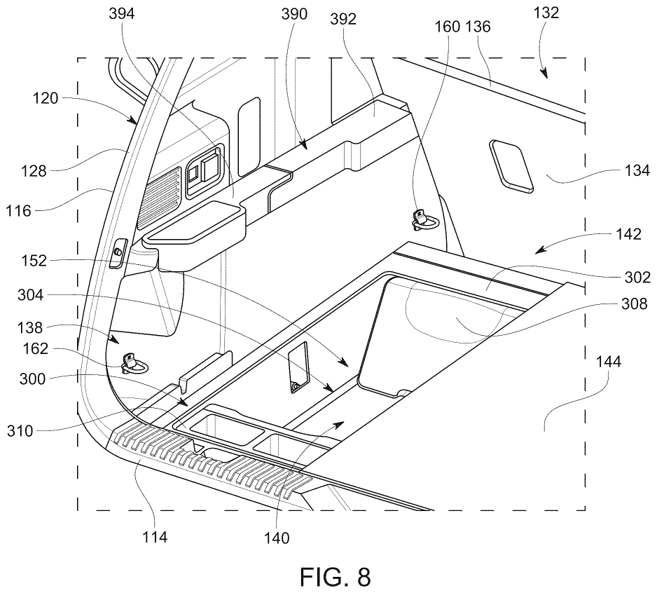

In the illustrated embodiment, the storage compartment 138 includes a first trunk space 140 and a second trunk space 142, shown in FIGS. 7 and 8. The second trunk space 142 is separated from the first trunk space 140 via at least one cargo floorboard, for example, a first cargo floorboard 144 and a second cargo floorboard 146, shown in FIG. 6. In an embodiment, the first trunk space 142 is the space defined downwardly of the floorboards 144, 146 and between the floor 126 of the vehicle body 120 and the floorboards 144, 146, while the second trunk space 142 is defined upwardly of the floorboards 144, 146, between the floorboards 144, 146 and the roof 124 in the vertical direction. Accordingly, the floorboards 144, 146 are arranged to cover the first trunk space 140 from above (i.e., top). When arranged covering the first trunk space 140, upper surfaces of the floorboards 144, 146 may be arranged aligned and flush with each other.

Moreover, as shown in FIG. 7, the first trunk space 140 may include a first area 150 structured to receive and store another spare tire 202 (e.g., temporary or donut tire) in a lying position or horizontal orientation, and a second area 152 arranged adjacent to the first area 150 in the lateral direction of the vehicle. Accordingly, the first area 150 extends, in the lateral direction, from a second sidewall 130 of the pair of sidewalls 128, 130 to the second area 152, while the second area 152 extends, in the lateral direction of the vehicle 100, from the first area 150 to a first sidewall 128 of the pair of sidewalls 128, 130. The second area 152 is smaller than the first area 150 and facilitates the positioning of the spare tire 200 in a vertically standing orientation. In the illustrated embodiment, the second area 152 is covered by the second floorboard 146, while the first area 150 is covered by the first floorboard 144.

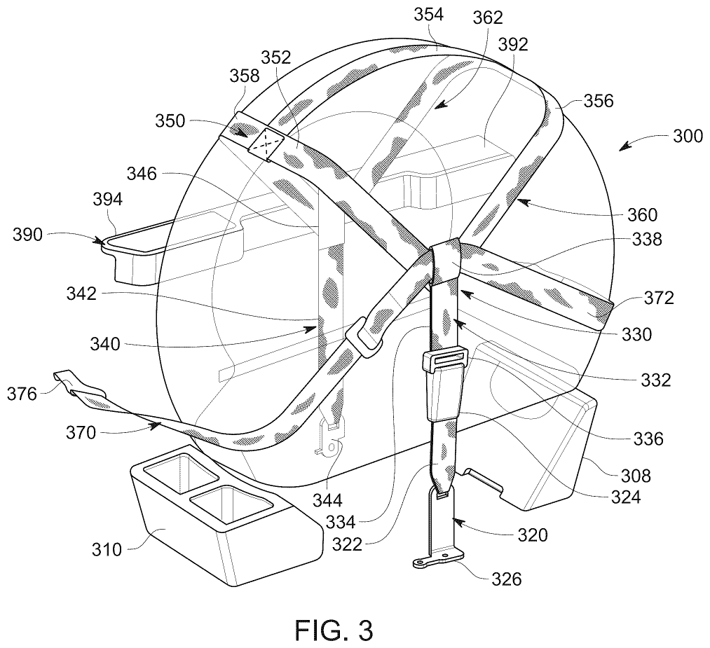

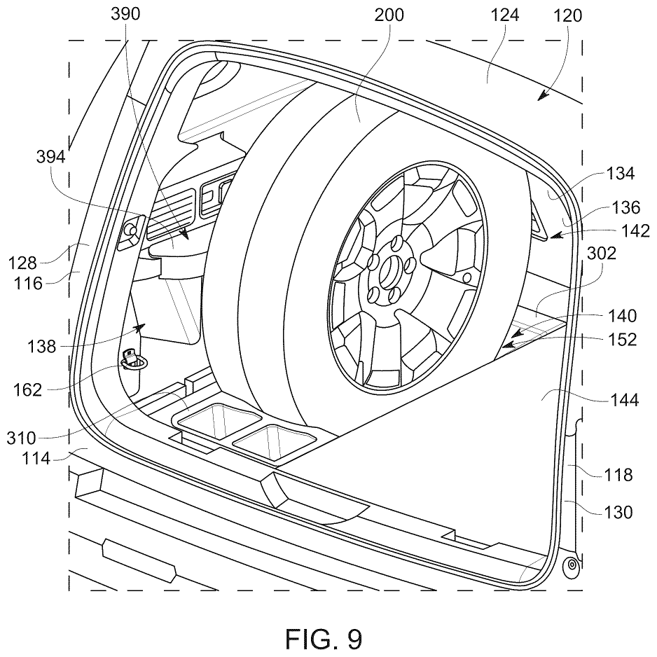

Referring to FIGS. 2 to 5 and 7 to 10, the spare tire kit 300 includes a tray 302, a pair or stoppers 308, 310, a first connector 320, and a second connector 330. The tray 302, best shown in FIGS. 7 and 8, may be removably arranged inside the second area 152 and defines a chamber 304 to receive the spare tire 200. In some embodiments, a width of the chamber 304 is substantially equal to a width of the spare tire 200. Further, the pair of stoppers 308, 310, shown in FIGS. 3, 4, and 8, may be removably arranged inside the tray 302 and arranged spaced apart from each other in a longitudinal direction. In other embodiments, the stoppers 308, 310 may be molded or cast as part of the tray 302. The stoppers 308, 310 are arranged inside the tray 302 to prevent motion or movement of the spare tire 200 in the longitudinal direction of the vehicle 100 when arranged inside the tray 302. As best shown in FIG. 8, a first stopper 308 is arranged proximate to the rear seat 136 of the vehicle 100, while a second stopper 310 is arranged proximate to the rear end 114 of the vehicle 100. In an embodiment, a length of the tray 302 and the lengths of the stoppers 308, 310 are selected such that when the spare tire 200 is arranged inside the tray 302 and between the stoppers 308, 310, ends of the stoppers 308, 310 that are arranged facing each other, contact the spare tire 200, while other ends stoppers are arranged contacting, respectively, front and rear walls of the tray 302, as shown in FIG. 9.

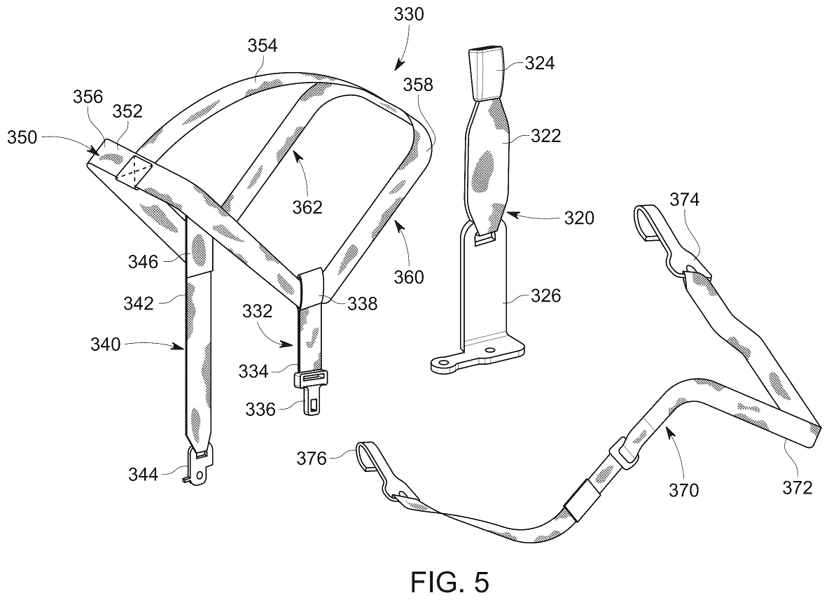

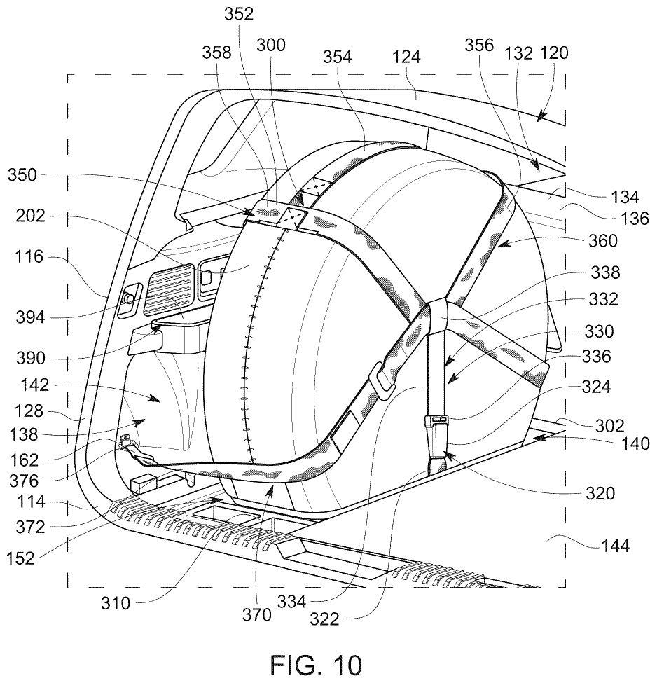

Further, to hold and secure the spare tire 200 in the vertically standing orientation and inside the tray 302, the spare tire kit 300 includes the first connector 320 disposed proximate to the first area 150 than the first sidewall 128 in the lateral direction, as shown in FIG. 10. Referring to FIGS. 3, 5, and 10, the first connector 320 is attached to the floor 126 of the vehicle body 120 and includes a strap 322 having a first end connected to the floor 126, and a buckle 324 attached to a second end of the strap 322. In the illustrated embodiment, the first connector 320 includes a bracket 326, as shown in FIGS. 3 and 5, that is bolted to the floor 126 of the vehicle body 120.

Moreover, the second connector 330, shown in FIGS. 3, 5, and 10, may be adapted to be removable engaged with the first connector 320 and the spare tire 200 to retain and secure the spare tire 200 inside the tray 302 in the vertically standing orientation. In the illustrated embodiment, the second connector 330 includes a first strap structure 332 adapted to be removably engaged with the first connector 320 and includes a first webbing 334, a tongue 336, best shown in FIGS. 3 and 5, connected to a first end of the first webbing 334, and a webbing loop 338 defined at a second end of the first webbing 334. The tongue 336 is inserted inside the buckle 324 to removably couple the first strap structure 332 to the first connector 320. It may be appreciated that the first strap structure 332 extends in a vertical direction, as shown in FIG. 10, when the second connector 330 is engaged with the spare tire 200 and first strap structure 332 is connected with the first connector 320 to secure the spare tire 200 inside the tray 302 and in the vertically standing orientation. In some embodiments, the first strap structure 332 and/or the first connector 320 may include a ratchet or tensioner attached to the first webbing 334 or the strap 322 to adjust the tension.

Further, the second connector 330 may include a second strap structure 340 arranged between the spare tire 200 and the first sidewall 128 of the vehicle 100 when the second connector 330 is engaged with the first connector 320. As shown, the second strap structure 340 includes a second webbing 342, a bolt-on coupler 344 arranged at a first end of the second webbing 342 and connected to the second webbing 342, and a second webbing loop 346 defined at a second end of the second webbing 342. The coupler 344 is bolted to the first sidewall 128 or the floor 126 of the vehicle 100.

In the illustrated embodiment, the second connector 330 also includes a third strap structure 350 connected to the first strap structure 332 and the second strap structure 340, and extending between the first strap structure 332 and the second strap structure 340. The third strap structure 350 includes a third webbing 352 having a loop shape, best shown in FIGS. 3 and 5, and connected to the first strap structure 332 and the second strap structure 340, and extending through the first webbing loop 338 and the second webbing loop 346. In some embodiments, the third webbing 352 may be stitched to the first webbing loop 338 and the second webbing loop 346. Additionally, the third strap structure 350 may include a fourth webbing 354 extending along a diameter or chord of the loop shaped third webbing 352 and with ends of the fourth webbing 354 connected to the diametrically opposite portions of the third webbing 352. In the illustrated embodiment, ends of the fourth webbing 354 are stitched to the third webbing 352. In this manner, the fourth webbing 354 divides the third webbing 352 into a first portion 356 that is connected to the first strap structure 332 and a second portion 358 that is connected to the second strap structure 340.

In the assembly of the second connector 330 with the spare tire 200, as shown in FIGS. 2 and 10, the third strap structure 350 is wrapped around the spare tire 200 with the fourth webbing 354 extending along an upper portion of a circumference of the spare tire 200, when arranged in vertically standing orientation, with the first portion 356 extending downwardly from the upper portion of the spare tire 200 and on one side of the spare tire 200, and the second portion 358 extending downwardly from the upper portion on an opposite side of the spare tire 200. In this manner, the first strap structure 332 and the first portion 356 of the third strap structure 350 together define a first Y-shaped structure 360 and the second strap structure 340 and the second portion 358 of the third strap structure 350 together defines a second Y-shaped structure 362 when the second connector 330 is secured to the spare tire 200 and removably engaged with the first connector 320.

Furthermore, the spare tire kit 300 may also include a cross-strap 370, shown in FIGS. 3, 5, and 10, removably engaged to the spare tire 200 and the first sidewall 128 of the vehicle body 120 to retain the spare tire 200 in the vertically standing orientation. In an embodiment, the cross-strap 370 includes a webbing, such as fifth webbing 372, a first hook 374 attached to a first end of the fifth webbing 372, and a second hook 376 attached to a second end of the fifth webbing 372. In the engagement of the cross-strap 370 with the spare tire 200 and the first sidewall 128, shown in FIGS. 2 and 10, the fifth webbing 372 extends through the first webbing loop 338 and the hooks 374, 376 are connected to the cargo tie downs 160, 162 connected to the first sidewall 128 of the vehicle body 120.

In an embodiment, a first cargo tie down 160, best shown in FIGS. 6 to 8, is arranged proximate to the rear seat 136, while a second cargo tie down 162 is the arranged proximate to the rear end 114 of the vehicle body 120. Further, the cross-strap 370 may include a tensioner or ratchet attached to the fifth webbing 372 to adjust the tension of the fifth webbing 372 upon engagement with the second connector 330 as well as the spare tire 200. The cross-strap 370 restricts the movement of the spare tire 200 in the lateral direction towards the second sidewall 130 of the vehicle body 120, when the spare tire 200 is arranged inside the tray 302 in the vertically standing orientation. The cross-strap 370 may include a ratchet attached to the fifth webbing 372 to facilitate an adjustment of tension of the fifth webbing 372.

Referring to FIGS. 2 to 4 and 6 to 8, to restrict the movement of the spare tire 200 in the lateral direction and towards the first sidewall 128, the spare tire kit 300 includes a wall spacer 390 attached to the first sidewall 128 and extending inwardly inside the storage compartment 138 from the first sidewall 128 in the lateral direction. As illustrated in FIGS. 6 to 8, the wall spacer 390 extends between the rear seat 136 and the rear end 114 of the vehicle body 120 in the longitudinal direction. A dimension of the wall spacer 390 in the lateral direction is selected such that a longitudinal side of the wall spacer 390 is arranged abutting the spare tire 200 when the spare tire 200 is secured inside the tray 302 in the vertical orientation, best shown in FIGS. 9 and 10. In the illustrated embodiment, the wall spacer 390 includes two spacer structures 392, 394 that are adapted to be removably engaged with each other. However, the wall spacer 390 may include a single piece or multiple pieces. Also, the wall spacer 390 may be removably attached to the first sidewall 128 using one or more Velcro.

A method of installing the spare tire kit 300 and the spare tire 200 inside an existing vehicle is now described. For installing the spare tire kit 300 inside the storage compartment of the existing vehicle, a technician may remove an existing floorboard (e.g., floorboard 146) and position the tray 302 in the second area 152 adjacent to the horizontal spare tire 200, as shown in FIG. 7. In some embodiments, before positioning the tray 302 inside the second area 152, the technician may cut or remove a floor covering or carpet that is arranged inside the second area 152, and connect or fasten the bracket 326 of the first connector 320 to the floor 126 via fasteners. It may be appreciated that the technician may position and connect the bracket 326 at a location proximate to the first spare tire 200 such that the first connector 320 is arranged on a first side of the tray 302. In some embodiments, an opening or a cut-out may be defined in a sidewall of the tray 302 to extend the strap 322 of the first connector 320 through the opening of the tray 302. Also, the technician may engage or attach the second connector 330 to the first sidewall 128 or the floor 126 of the existing vehicle. For example, the technician may bolt the coupler 344 to the first sidewall 128 or the floor 126.

After positioning the tray 302 inside the second area 152, the technician may position the pair of stoppers 308, 310 inside the tray 302 such that slanted sides of the two stoppers 308, 310 are arranged facing each other and a space is defined between the stoppers 308, 310 to position the spare tire 200 inside the tray 302, as shown in FIG. 8. Moreover, the technician may engage the wall spacer 390 with the first sidewall 128, as shown in FIGS. 6 to 10. It may be appreciated that the wall spacer 390 and the pair of stoppers 308, 310 may include removable or adjustable fasteners, such as hook and loop fasteners, to secure the stoppers 308, 310 and the wall spacer 390 at the suitable positions. In this manner, the spare tire kit 300 is installed inside the storage compartment of an existing vehicle. It may be appreciated that the cross-strap 370 may be stored inside the tray 302 for retrieval and securing the spare tire 302 in the vertically standing orientation inside the tray 302.

To position and secure the spare tire 200, a user arranges the spare tire 200 inside the tray 302, between the slanted sides of the pair of stoppers 308, 310, in the vertically standing orientation, as shown in FIG. 9. It may be appreciated that spare tire 200 abuts the wall spacer 390, when the spare tire 200 is arranged inside the tray 302 in the vertically standing orientation, to restrict the lateral movement of the spare tire 200 towards the first sidewall 128. After positioning the spare tire 200 inside the tray 302, the user secures the spare tire 200 using the second connector 330 and the first connector 320, as shown in FIG. 10. For example, the user may arrange or wrap the second connector 330 around the spare tire 200 such that the fourth webbing 354 extends, in a longitudinal direction, along an upper portion of a circumference of the spare tire 200 and the potion of the third webbing 352 is arranged on a first side of spare tire 200 and another portion of the third webbing 352 is disposed on a second side, opposite to the first side, of the spare tire 200. Moreover, the second strap structure 340 is arranged between the first sidewall 128 and the spare tire 200 (i.e., second side of the spare tire 200), and the first strap structure 332 is arranged on an opposite side (i.e., first side) of the spare tire 200 to that of the second strap structure 340, as shown in FIG. 10.

Upon suitably wrapping and engaging the second connector 330 with the spare tire 200, the user engages the second connector 330 to the first connector 320 by inserting the tongue 336 of the first strap structure 332 inside the buckle 324 of the first connector 320. Further, tension in the second connector 330 and the first connector 320 may be adjusted by operating a tensioner of the first connector 320 and/or the second connector 330. In this manner, the user secures, the spare tire 200 inside the tray 302 in the vertically standing orientation. Additionally, or optionally, as shown in FIG. 10, the user may engage the cross-strap 370 with the second connector 330 and the first sidewall 128 to prevent or restriction the lateral movement of the spare tire 200. For engaging the cross-strap 370, the user may extend the cross-strap 370 through the first webbing loop 338 such that the hooks 374, 376 of the cross-strap 370 are arranged on opposite sides of the first webbing loop 338 and connects the hooks 374, 376 with cargo tie downs 160, 162. Accordingly, the spare tire 200 is arranged between the first sidewall 128 and the cross-strap 370 in the lateral direction. Moreover, a tension in the cross-strap 370 may be adjusted by operating a tensioner of the cross-strap 370. In this manner, the spare tire kit 300 facilitates in retaining an additional spare tire (i.e., two spare tires inside a storage compartment of a vehicle). In other embodiments, each side of the storage compartment 138 may include a spare tire kit 300 enabling two spare tires to be positioned and secured in a vertically standing orientation in the storage compartment 138.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A spare tire kit for arranging and securing a spare tire, in a vertically standing orientation, inside a storge compartment of a vehicle, the spare tire kit comprising:
a tray adapted to be arranged inside the storage compartment and configured to receive the spare tire in the vertically standing orientation;
a pair of stoppers adapted to be arranged, spaced apart from each other, inside the tray, wherein the spare tire is arranged between the pair of stoppers to restrict the movement of the spare tire in a longitudinal direction of the vehicle;
a first connector adapted to be attached to a floor of the vehicle on a first side of the tray and facilitates the securing the spare tire inside the tray; and
a second connector adapted to be connected to a sidewall of the vehicle or the floor of vehicle on a second side of the tray, wherein the second connector is configured to wrap around the spare tire and removably engaged with the first connector to secure the spare tire inside the tray.

2. The spare tire kit of claim 1, wherein the first connector comprises
a strap having a first end and a second end,
a bracket attached to the strap and arranged at the first end of the strap, the bracket is configured to be fastened to the floor of the vehicle, and
a buckle attached to the strap and disposed at the second end of the strap, wherein the buckle is adapted to be removably connected to the second connector.

3. The spare tire kit of claim 1, wherein the second connector comprises
a first strap structure adapted to be removable engaged with the first connector and arranged on a first side of the spare tire when the second connector is wrapped around the spare tire,
a second strap structure adapted to be attached to one of the sidewall or the floor of the vehicle and coupled to the first strap structure, and
a third strap structure configured to wrap around the spare tire and coupling the first strap structure and the second strap structure.

4. The spare tire kit of claim 3, wherein the first strap structure comprises
a first webbing defining a first webbing loop and the third strap structure extends through the first webbing loop, and
a tongue attached to the first webbing and arranged opposite to the first webbing loop, wherein the tongue removably engage the first strap structure to the first connector.

5. The spare tire kit of claim 3, wherein the second strap structure comprises
a second webbing defining a second webbing loop and the third strap structure extends through the second webbing loop, and
a coupler attached to the second webbing and arranged opposite to the second webbing loop, wherein the coupler is adapted be attached to the one of the sidewall or the floor of the vehicle, coupling the second connector with the one of the sidewall of the floor of the vehicle.

6. The spare tire kit of claim 3, wherein the third strap structure comprises
a third webbing arranged in a loop shape and extending through the first webbing loop and the second webbing loop and adapted to wrap around the spare tire, and
a fourth webbing extending along a diameter of the loop shape and connected to the third webbing, dividing the third webbing into a first portion and a second portion, wherein the first portion is connected to the first strap structure and the second portion is connected to the second strap structure.

7. The spare tire kit of claim 3 further comprises a cross-strap adapted to be removable engaged to the first strap structure and the sidewall of the vehicle, wherein the cross-strap extends in a longitudinal direction of the vehicle to secure the spare tire inside the tray and to restrict a lateral movement of the spare tire.

8. The spare tire kit of claim 7, wherein the cross-strap comprises a fifth webbing adapted to engage with the first strap structure and a pair of hooks attached to the webbing and arranged at two ends of the webbing, wherein the pair of hooks are adapted to engage with sidewalls of the vehicle.

9. The spare tire kit of claim 1 further comprises a wall spacer adapted to be removably attached to the sidewall of the vehicle, wherein the wall spacer is adapted to contact the spare tire when arranged inside the tray in the vertically standing orientation, to restrict the movement of the spare tire in a lateral direction towards the sidewall.

10. A vehicle, comprising:
a vehicle body defining a storage compartment;
the storage compartment comprising a first area and a second area adjacent to the first area;
a tray arranged inside the second area of the storage compartment, wherein the tray extends in a longitudinal direction of the vehicle to receive a spare tire in a vertically standing orientation;
a pair of stoppers arranged inside the tray and disposed spaced apart from each other in a longitudinal direction top receive the spare tire therebetween, wherein the pair of stoppers restrict the movement of the spare tire in a longitudinal direction of the vehicle;
a first connector attached to a floor of the vehicle on a first side of the tray and facilitates a securing of the spare tire inside the tray; and
a second connector connected to a sidewall of the vehicle or the floor of vehicle on a second side of the tray and configured to wrap around the spare tire and removably engaged with the first connector to secure the spare tire inside the tray.

11. The vehicle of claim 10, wherein the first connector comprises
a strap having a first end and a second end,
a bracket attached to the strap and arranged at the first end of the strap, the bracket is fastened to the floor of the vehicle, and
a buckle attached to the strap and disposed at the second end of the strap, wherein the buckle is adapted to be removably connected to the second connector.

12. The vehicle of claim 10, wherein the second connector comprises
a first strap structure adapted to be removable engaged with the first connector and arranged on a first side of the spare tire when the second connector is wrapped around the spare tire,
a second strap structure attached to one of the sidewall or the floor of the vehicle and coupled to the first strap structure, and
a third strap structure configured to wrap around the spare tire and coupling the first strap structure and the second strap structure.

13. The vehicle of claim 12, wherein the first strap structure comprises
a first webbing defining a first webbing loop and the third strap structure extends through the first webbing loop, and
a tongue attached to the first webbing and arranged opposite to the first webbing loop, wherein the tongue removably engage the first strap structure to the first connector.

14. The vehicle of claim 12, wherein the second strap structure comprises
a second webbing defining a second webbing loop and the third strap structure extends through the second webbing loop, and
a coupler attached to the second webbing and arranged opposite to the second webbing loop, wherein the coupler is attached to the one of the sidewall or the floor of the vehicle, coupling the second connector with the one of the sidewall of the floor of the vehicle.

15. The vehicle of claim 12, wherein the third strap structure comprises
a third webbing arranged in a loop shape and extending through the first webbing loop and the second webbing loop and adapted to wrap around the spare tire, and
a fourth webbing extending along a diameter of the loop shape and connected to the third webbing, dividing the third webbing into a first portion and a second portion, wherein the first portion is connected to the first strap structure and the second portion is connected to the second strap structure.

16. The vehicle of claim 12 further comprises a cross-strap adapted to be removable engaged to the first strap structure and the sidewall of the vehicle, wherein the cross-strap extends in a longitudinal direction of the vehicle to secure the spare tire inside the tray and to restrict a lateral movement of the spare tire.

17. The vehicle of claim 16 further comprises a pair of cargo tie downs attached to the sidewall of the vehicle and the cross-strap includes a pair of hooks adapted to removably engage with the pair of cargo-tie downs to secure the spare tire inside the tray and to restrict a lateral movement of the spare tire.

18. The vehicle of claim 10 further comprises a wall spacer removably attached to the sidewall of the vehicle, wherein the wall spacer is adapted to contact the spare tire when arranged inside the tray in the vertically standing orientation, to restrict the movement of the spare tire in a lateral direction towards the sidewall.

19. A spare tire kit for arranging and securing a spare tire, in a vertically standing orientation, inside a storge compartment of a vehicle, the spare tire kit comprising:
a tray adapted to be arranged inside the storage compartment and configured to receive the spare tire in the vertically standing orientation;
a first connector adapted to be attached to a floor of the vehicle on a first side of the tray and facilitates the securing the spare tire inside the tray;
a second connector adapted to be connected to a sidewall of the vehicle or the floor of vehicle on a second side of the tray, wherein the second connector is configured to wrap around the spare tire and removably engaged with the first connector to secure the spare tire inside the tray;
a pair of stoppers adapted to be arranged inside the tray with the spare tire to be arranged between the pair of stoppers to restrict the movement of the spare tire in a longitudinal direction of the vehicle;
a cross-strap adapted to be removable engaged to the second connector and the sidewall of the vehicle, wherein the cross-strap extends in a longitudinal direction of the vehicle to secure the spare tire inside the tray and to restrict a lateral movement of the spare tire in a direction away from the sidewall of the vehicle; and
a wall spacer adapted to be removably attached to the sidewall of the vehicle, wherein the wall spacer is adapted to contact the spare tire when arranged inside the tray in the vertically standing orientation, to restrict a lateral movement of the spare tire towards the sidewall.

20. The spare tire kit of claim 19, wherein the wall spacer includes two spacer structures adapted to be removably engaged with each other.
